(19) United States
(12) Patent Application Publication
(10) Pub. No.: US 2014/0085310 A1
(43) Pub. Date: Mar. 27, 2014

(54) FONT GENERATING SYSTEM OF DISPLAY

(71) Applicant: ARPHIC TECHNOLOGY CO., LTD., New Taipei City (TW)

(72) Inventors: Fu-Sheng Wu, Taoyuan County (TW); Yi-Hui Huang, Taipei City (TW); Hsueh-Chih Huang, Taipei City (TW)

(73) Assignee: ARPHIC TECHNOLOGY CO., LTD., New Taipei City (TW)

(21) Appl. No.: 13/682,717

(22) Filed: Nov. 20, 2012

(30) Foreign Application Priority Data
Sep. 27, 2012 (TW) 101135519

(51) Int. Cl. G06F 17/21

(52) U.S. Cl. CPC G06F 17/21
USPC 345/467

(57) ABSTRACT

A font generating system of a display includes a variable converting module, a database and a font generator. The variable converting module is used to receive a first set of font parameters and environmental parameters of the display and to generate a second set of font parameters according to the first set of font parameters and the environmental parameters of the display. The database is used to store font data of a plurality of characters. The font generator is used to generate images of the characters according to the second set of font parameters and font data of the plurality of characters.

### BACKGROUND OF THE INVENTION

1. Field of the Invention

The present invention relates to a font generating system of a display, especially a font generating system of a display capable of generating images of characters according to environmental parameters of the display.

2. Description of the Prior Art

The computer device including a display has been widely used for processing documents and browsing websites, thus playing an important role in daily life. Computer devices comprise devices such as personal computers, notebooks, mobile phones and intelligent global positioning systems (GPS). Users can obtain information through viewing characters displayed on the screens of the aforementioned computer devices.

With prior art font generating technologies applied in computer devices, when the environmental parameters are changed, a new set of fonts should be redesigned or the users should input parameters again to accordingly change the fashion of presenting the characters. For example, when watching characters displayed on a large-sized television, e.g. a 42 inches television, the fonts of the characters are required to be displayed in a large fashion, so that the users can easily recognize the characters. In this way, the structures of the characters need to be configured wide and the features of the strokes of the characters need to be configured obviously. The features of a stroke can be realized from that a stroke may comprise different widths and shapes at different portions, instead of being a straight line. As to watching characters displayed on the screen of a mobile phone, the fonts of the characters are required to be displayed in a small fashion, so that the users can easily recognize the characters. In this way, the structures of the characters need to be configured narrow and the features of the strokes of the characters are not considered, to avoid the strokes overlapping each other.

In view of the above, if the characters of an electronic document or a web site are easy to recognize on a small-sized panel, the characters will be difficult to be recognized on a large-sized panel due to the structures of the characters being narrow. On the contrary, if the characters of an electronic document or a web site are easy to recognize on a large-sized panel, the characters will overlap each other and will exceed the character boundaries on a small-sized panel. That is, the prior art font generating technologies can not generate fonts suitable for various sized panels. When relatively large characters and relatively small characters in an electronic document or a web site are displayed simultaneously on the screen, the readability will be significantly reduced. Further, the prior art font generating technologies can not generate characters according to the background colors of the display and the colors of the characters, or according to the brightness of the ambient light. Therefore, the users have to manually adjust the fonts of the characters. The prior art methods are not convenient for users.

### SUMMARY OF THE INVENTION

An embodiment of the present invention relates to a font generating system of a display, which comprises a variable converting module, a database and a font generator. The variable converting module is used to receive a first set of font parameters and environmental parameters of the display and to generate a second set of font parameters according to the first set of font parameters and the environmental parameters of the display. The database is used to store font data of a plurality of characters. The font generator is used to generate images of the characters according to the second set of font parameters and font data of the plurality of characters.

An embodiment of the present invention relates to a method for generating fonts of a display. The method comprises receiving a first set of font parameters and environmental parameters of the display, and generating a second set of font parameters according to the first set of font parameters and the environmental parameters of the display, and generating images of the characters according to the second set of font parameters and font data of the plurality of characters.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a font generating system applied in a display.

FIG. 2 shows a flowchart of controlling the font generating system in FIG. 1 to generate fonts.

FIG. 3 shows the key points and width values of a stroke.

FIG. 4A shows the small-sized font of a character stored in the database.

FIG. 4B shows the large-sized font of a character stored in the database.

FIG. 5A shows the lightface font of a character stored in the database.

FIG. 5B shows the boldface font of a character stored in the database.

FIG. 6A shows an unadjusted character plane.

FIG. 6B shows the unadjusted character plane in FIG. 6A being adjusted to form an adjusted character plane.

### DETAILED DESCRIPTION

Some phrases are referring to specific elements in the present specification and claims, please notice that the manufacturer might use different terms to refer to the same elements. However, the definition between elements is based on their functions instead of their names. Further, in the present specification and claims, the term “comprising” is open type and should not be viewed as the term “consisted of”.

The embodiments and figures are provided as follows in order to illustrate the present invention in detail, but please notice that the claimed scope of the present invention is not limited by the provided embodiments and figures.

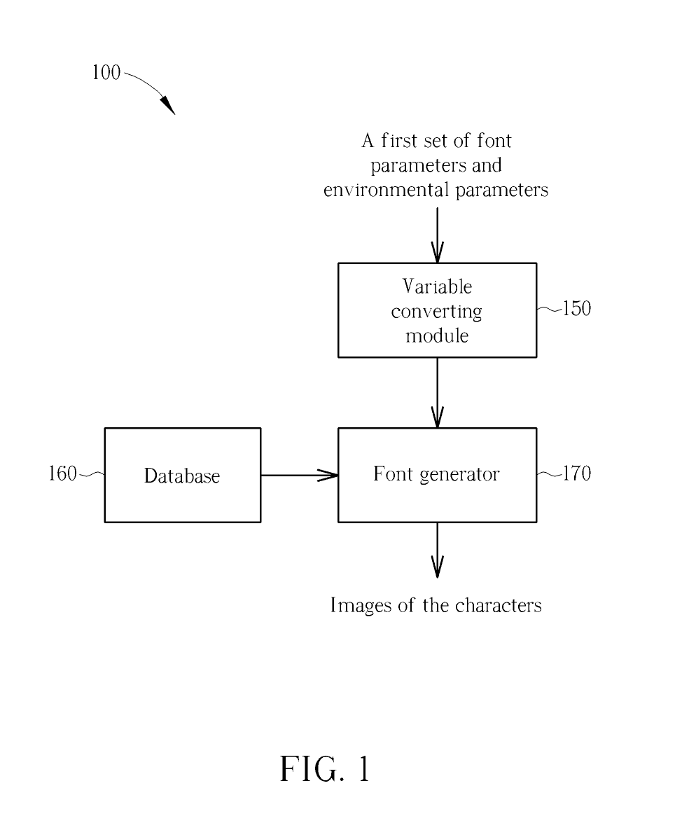

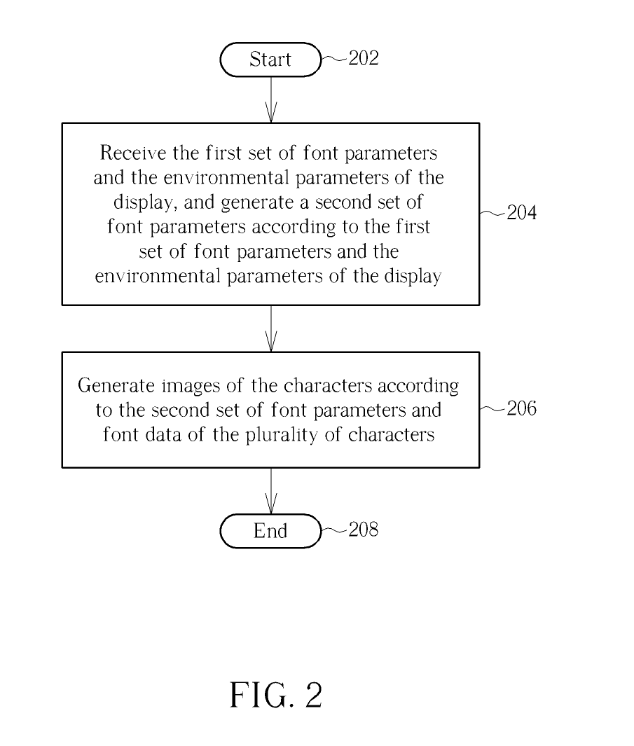

Please refer to FIGS. 1 and 2. FIG. 1 shows a font generating system 100 applied in a display. The font generating system 100 comprises a variable converting module 150, a database 160 and a font generator 170. The variable converting module 150 is used to receive a first set of font parameters and environmental parameters of the display and to generate a second set of font parameters according to the first set of font parameters and the environmental parameters of the display. The database 160 is used to store font data of a plurality of characters. The font generator 170 is used to generate images of the characters according to the second set of font parameters and font data of the plurality of characters. FIG. 2 shows a flowchart of controlling the font generating system 100 in FIG. 1 to generate fonts. The descriptions are as follows:

Step 202: start;

Step 204: receive the first set of font parameters and the environmental parameters of the display, and generate a second set of font parameters according to the first set of font parameters and the environmental parameters of the display;

Step 206: generate images of the characters according to the second set of font parameters and font data of the plurality of characters;

Step 208: end.

In Step 204, the first set of font parameters and the environmental parameters of the display are received by the variable converting module 150 first, and then the second set of font parameters are generated according to the received first set of font parameters and environmental parameters of the display, and the second set of font parameters are outputted to the font generator 170. The database 160 stores data substantially comprising all of the characters of the language system, and the data can be further updated and expanded. In Step 206, after the font generator 170 receives the second set of font parameters, the font generator 170 can obtain required data of the characters to be displayed from the database 160, to generate images of the characters accordingly.

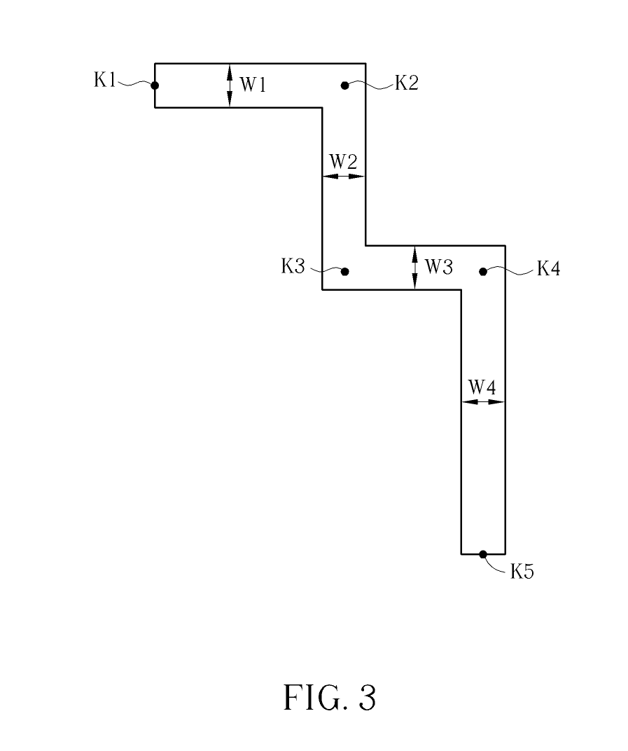

For example, the first set of font parameters can be viewed as parameters of fonts yet to be outputted, and comprises font parameters of characters such as sizes, strokes, attributes, colors, gamma values and/or grey levels of fonts. The stroke parameter of a character comprises key points and width values of each stroke of the character. Please refer to FIG. 3, which shows the key points and width values of a stroke “ [symbol] ”. The stroke “ [symbol] ” is one stroke of the Chinese character “ [symbol] ”. The stroke “ [symbol] ” includes 5 key points K1 and 4 width values W1 to W4. A width value is set between each two key points. For example, the width value of a partial stroke formed by the key points K2 and K3 is W2.

The attribute parameter of a character refers to the writing style of the character, such as the typefaces SimKai, PmingLiu and Times New Roman. The color parameter of a character can refer to the color presented by the character. However, the color parameter can be a parameter relating to the ratio of the color of the character and the color of the background of a current frame. The gamma value and/or grey level of a character can be viewed as the color density and the tone presented by the character. For example, if the grey level of a character is 0, the character will present white color. If the grey level of the character is 255, the character will present black color. The gamma value of a character can be generated through transforming the grey level of the character, thus will not be further described.

The environmental parameters of a display comprise ambient light, backlight brightness, display types, contrast values and/or screen resolutions. The ambient light parameter can be values relating to daylight or the light of a daylight lamp. The backlight brightness parameter can be values relating to the backlight brightness of a display. The display types comprise CRT, LCD, LED and OLED displays.

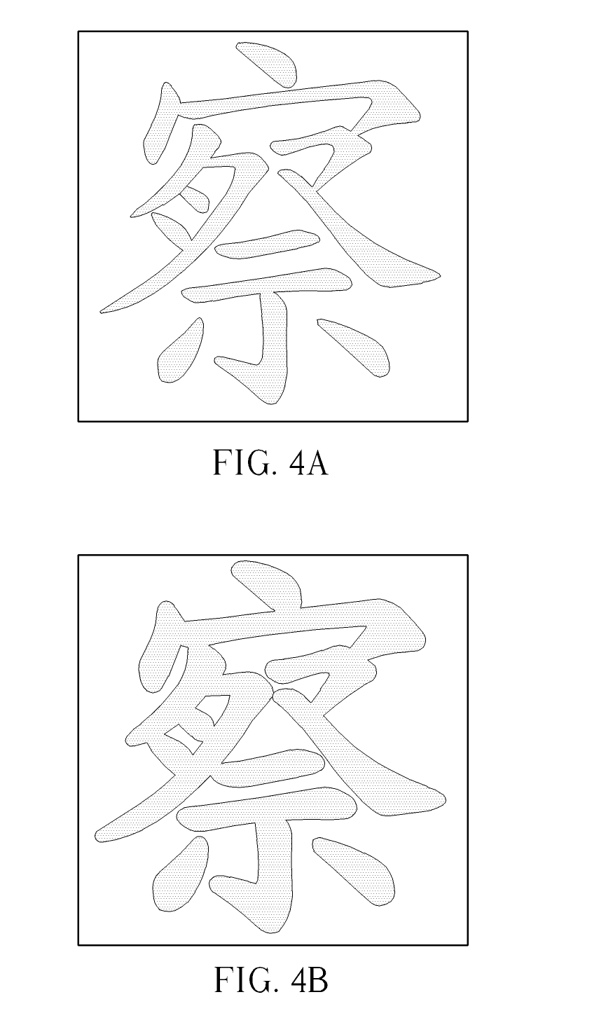

The font data of the plurality of characters stored in the database 160 comprises large-sized fonts of the plurality of characters and small-sized fonts of the plurality of characters. Thus, the font generator 170 can generate the second set of the font parameters with an interpolation method or other algorithms according to the environmental parameters of the display. Please refer to FIGS. 4A and 4B. FIG. 4A shows the small-sized font of a character stored in the database 160. FIG. 4B shows the large-sized font of a character stored in the database 160. In FIG. 4A, the key points of the Chinese character “ [symbol] ” are configured for users easier to clearly recognize. The configuration in FIG. 4A is suitable for small-sized display panels. However, in FIG. 4B, the key points of the Chinese character “ [symbol] ” are configured to stress the features of the strokes of the Chinese character “ [symbol] ” to improve the visual effect. This configuration is suitable for small-sized display panels. The configuration in FIG. 4B is suitable for large-sized display panels. In both FIGS. 4A and 4B, no strokes overlap each other and no strokes exceed the character boundaries, thus the font generated by interpolating the font in FIGS. 4A and 4B can avoid the situation that strokes overlap each other or strokes exceed the character boundaries. Therefore, whether the font generating system 100 is applied in a small-sized or a large sized display, the characters shown on the screen have proper scale and are easier to be recognized.

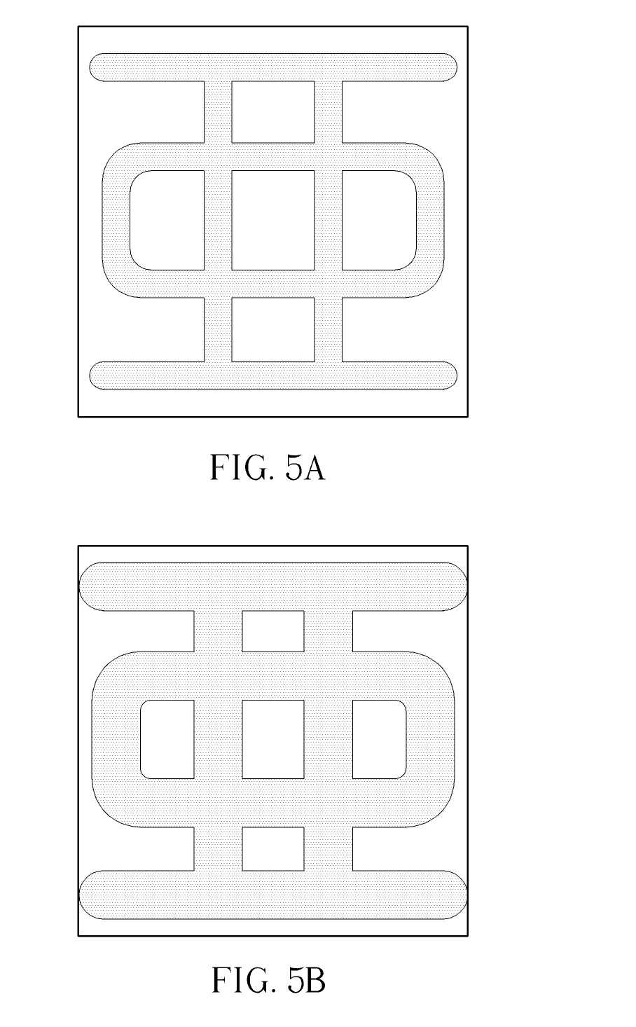

Besides, the font data of the plurality of characters stored in the database 160 comprises at least one boldface font of the plurality of characters and at least one lightface font of the plurality of characters. Please refer to FIGS. 5A and 5B. FIG. 5A shows the lightface font of a character stored in the database 160. FIG. 5B shows the boldface font of a character stored in the database 160. In FIG. 5A, the stroke widths of the Chinese character “ [symbol] ” are configured for users easier to clearly recognize when watching a small-sized display panel, while in FIG. 5B, the stroke widths of the Chinese character “ [symbol] ” are configured to be more noticeable when watching a large-sized display panel. In both FIGS. 5A and 5B, no strokes overlap each other and no strokes exceed the character boundaries, thus the font generated by interpolating the font in FIGS. 5A and 5B can avoid the situation that strokes overlap each other or strokes exceed the character boundaries. Therefore, whether the font generating system 100 is applied in a small-sized or a large sized display, the characters shown on the screen have proper scale and are easier to be recognized.

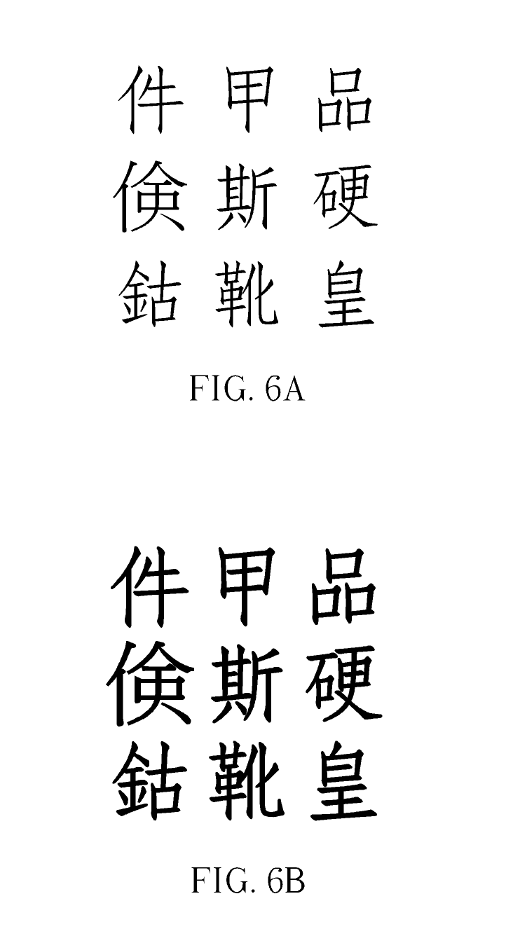

Moreover, the present invention comprises adjusting the character plane parameter of the first set of font parameters to generate the second set of font parameters, to improve the readability. Please refer to FIGS. 6A and 6B. FIG. 6A shows an unadjusted character plane. FIG. 6B shows the unadjusted character plane in FIG. 6A being adjusted to form an adjusted character plane. In FIG. 6A, the spacing between each two characters is large, thus making the character plane of each character appear to be small and making the characters hard to be recognized. This deteriorates the readability. However, in FIG. 6B, the character plane of each character are enlarged and the spacing between each two characters is reduced, thus making the characters easier to be recognized and improving the readability.

Further, the present invention comprises adjusting the grey level/gamma values of the first set of font parameters to generate the second set of font parameters, to improve the readability. For example, when a user is watching the frame with black characters and a white background on the screen, because the characters are substantially presented in black and the background is substantially presented white, the visual contrast will be too strong for the user to watch for a long time. In the present invention, the situation can be improved by lowering the color tone of the background through adjusting the grey level/gamma values of the background, so that the user will be less tired to watch the screen for a long time.

For another example, when a user is watching the frame with white characters and a black background on the screen, because the characters are substantially presented in white and the background is substantially presented black, the white characters will visually appear to be dim and are hard to be recognized. In the present invention, the situation can be improved by strengthening the color tone of the white characters, thus improving the readability.

In the configuration of the font generating system 100 of the present invention, the second set of font parameters can be generated according to various first set of font parameters and various environmental parameters of the display. Those parameters can be singly or jointly used to generate the second set of font parameters. In other words, in the font generating system 100, at least one parameter of the font parameters and the environmental parameters is concerned to generate an image with characters suitable for users to watch. Any means or methods utilizing the parameters of fonts or the environment of the display belong to the claimed scope of the present invention.

In view of above, through utilizing the font generating system 100 of the present invention, high quality fonts can be automatically generated without the engineers redesigning fonts or user manually inputting parameters again.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A font generating system of a display, comprising:
a variable converting module for receiving a first set of font parameters and environmental parameters of the display, generating a second set of font parameters according to the first set of font parameters and the environmental parameters of the display;
a database for storing font data of a plurality of characters; and
a font generator, for generating images of the characters according to the second set of font parameters and font data of the plurality of characters.

2. The font generating system of claim 1, wherein the first set of font parameters comprises sizes, strokes, attributes, colors, gamma values and/or grey levels of fonts.

3. The font generating system of claim 1, wherein the environmental parameters of the display comprise ambient light, backlight brightness, display types, contrast values and/or screen resolutions.

4. The font generating system of claim 1, wherein the font data of the plurality of characters comprises large-sized fonts of the plurality of characters and small-sized fonts of the plurality of characters.

5. The font generating system of claim 1, wherein the font data of the plurality of characters comprises boldface fonts of the plurality of characters and lightface fonts of the plurality of characters.

6. A method for generating fonts of a display, comprising:
receiving a first set of font parameters and environmental parameters of the display, and generating a second set of font parameters according to the first set of font parameters and the environmental parameters of the display; and
generating images of the characters according to the second set of font parameters and font data of the plurality of characters.

7. The method of claim 6, wherein the first set of font parameters comprises sizes, strokes, attributes, colors, gamma values and/or grey levels of fonts.

8. The method of claim 6, wherein the environmental parameters of the display comprise ambient light, backlight brightness, display types, contrast values and/or screen resolutions.

9. The method of claim 6, wherein the font data of the plurality of characters comprises large-sized fonts of the plurality of characters and small-sized fonts of the plurality of characters.

10. The method of claim 6, wherein the font data of the plurality of characters comprises boldface fonts of the plurality of characters and lightface fonts of the plurality of characters.
